(19) United States
(12) Patent Application Publication
(10) Pub. No.: US 2024/0189709 A1
(43) Pub. Date: Jun. 13, 2024

(54) USING IMAGES OF UPPER BODY MOTION ONLY TO GENERATE RUNNING VR CHARACTER

(71) Applicant: Sony Interactive Entertainment LLC, San Mateo, CA (US)

(72) Inventors: Daisuke Kawamura, San Mateo, CA (US); Udupi Ramanath Bhat, San Mateo, CA (US)

(21) Appl. No.: 18/064,824

(22) Filed: Dec. 12, 2022

(51) Int. Cl. A63F 13/428; A63F 13/213; G06V 40/10; G06V 40/20

(52) U.S. Cl. CPC A63F 13/428; A63F 13/213; G06V 40/10; G06V 40/28

(57) ABSTRACT

A video game player's upper body pose and/or motion can be used for controlling lower body motion of a game character. For example, arm swinging can translate to video game character running. Raising both hands above the user's head can translate to video game character jumping. Leaning to the left or right can translate to video game character movement in the left or right directions, respectively. Additionally, raising a single hand can translate to selecting a user interface button.

### FIELD

The disclosure below relates generally to using images of upper body motion to generate running and other motions for a virtual character.

### BACKGROUND

As understood herein, electronic video game controllers can be very complex. As such, the controllers can prevent children below a certain age from effectively using them to play video games.

### SUMMARY

The disclosure below relates to using a video game player's upper body motion and pose for a running-type game or other type of video game. A device like a video game console can use a depth-sensing smart camera to detect the upper body motion and translate the body pose/motion to character control keys. Easy and intuitive inputs are thereby enabled for enhanced gameplay. Thus, for example, a parent and toddler might play the same game together in front of the same depth-sensing camera using their bodies as video game controllers.

As a more-specific example, a father might set the smart camera as a game controller. His four-year-old daughter may then stand in front of the camera and the television itself and start the game. The daughter might then go through a tutorial screen and then raise her left hand to start the main session. The daughter might then, during the main session, tilt her body sideways to control her character's running direction. The father might concurrently stand in front of the camera/TV (next to his daughter) during a multiplayer experience and then pose with both of his hands over his head to command his own character to jump. Both the father and daughter might also swing their arms to make their respective characters run faster. Thus, spine angle may be used to change character direction and upper body motion may be used to command the character to take additional/different actions with the character's lower body. Also note that a single arm up pose as held for a threshold period of time may be interpreted as a user interface button press.

Accordingly, in one aspect an apparatus includes at least one processor configured to receive input from a camera and, based on the input, identify at least one factor related to a user's upper body. The processor is also configured to, based on identification of the at least one factor related to the user's upper body, control lower body motion of a video game character according to the at least one factor.

In some example implementations, the at least one factor may include an upper body lean to the left and/or right. So in certain examples the processor may be configured to, based on identification of the upper body lean, control the lower body motion of the video game character to move in a direction indicated by the upper body lean.

Also in some example implementations, the at least one factor may include upper body arm motion. So in certain examples the processor may be configured to, based on identification of upper body motion that includes arm pumping, control the lower body motion of the video game character to run.

In addition to the above, in some examples the at least one factor may include two hands above the user's head, and here the processor may be configured to control the lower body motion of the video game character to jump based on identification of the two hands above the user's head.

Additionally, in some embodiments the input may be first input, and the processor may be configured to receive second input from the camera, identify a raised hand based on the second input from the camera, and begin presenting a video game in which the video game character is controlled according to the at least one factor based on identification of the raised hand.

As another example, here again the input may be first input, and the processor may be configured to receive second input from the camera and select a first selector presented on a left-hand side of a display based on the second input indicating a raised left hand. Or based on the second input indicating a raised right hand, the processor may be configured to select a second selector presented on a right-hand side of a display, where the second selector is different from the first selector.

Also in various example implementations, the apparatus may include the camera. The camera may be a depth-sensing camera if desired.

In another aspect, a method includes receiving input from a camera and, based on the input, identifying at least one factor related to a user's upper body. The method also includes, based on identifying the at least one factor related to the user's upper body, controlling execution of a computer simulation to indicate lower body motion of a simulation character according to the at least one factor.

In various examples, the computer simulation may include a game.

Also in various examples, the at least one factor may include an upper body lean to the left or right. Here the method may include, based on identifying the upper body lean, controlling execution of the computer simulation to indicate the lower body motion of the simulation character to move in a direction indicated by the upper body lean.

As another example, the at least one factor may include arm swinging, and here the method may include controlling execution of the computer simulation to indicate the simulation character as running based on identifying the arm swinging.

As still another example, the at least one factor may include two hands above the user's head, and here the method may include controlling execution of the computer simulation to indicate the simulation character as jumping based on identifying the two hands above the user's head.

In addition to or in lieu of the above, in certain instances the input may be first input and the method may further include receiving second input from the camera and selecting a selector presented on a display based on the second input indicating a raised hand.

In still another aspect, a device includes at least one computer storage that is not a transitory signal. The storage includes instructions executable by at least one processor to receive input from a camera and, based on the input, identify at least one factor related to a user's upper body. The instructions are also executable to, based on identification of the at least one factor related to the user's upper body, control execution of a computer simulation to indicate lower body motion in the computer simulation according to the at least one factor.

In various examples, the lower body motion may include running and/or jumping.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a user standing in front of an example hardware setup that may be used consistent with present principles;

FIG. 3 illustrates example feature point detection that may be used for upper body pose/motion tracking consistent with present principles;

FIG. 4 shows the user raising a hand to command the computer to begin a video game instance consistent with present principles;

FIG. 5 shows the user leaning to the left in the real world to command a video game character to move left consistent with present principles;

FIG. 6 shows the user leaning to the right in the real world to command the video game character to move right consistent with present principles;

FIG. 7 shows the user raising his hands above his head in the real world to command the video game character to jump consistent with present principles;

FIG. 8 shows the user swinging his arms back and forth in the real world to command the video game character to walk/run consistent with present principles;

FIG. 9 shows an example play screen of the example video game consistent with present principles;

FIG. 10 shows left-side and right-side selectors presented on a display, where the selectors may be selected by respective left or right hand raises consistent with present principles;

FIG. 11 shows a child leaning to the left to control a video game character to move to the left within the video game consistent with present principles;

FIG. 12 shows example logic for training a machine learning model to operate consistent with present principles;

FIG. 13 shoes example overall logic for translating upper body movement into lower body character responses consistent with present principles;

FIG. 14 shows detailed logic for translating various example upper body movements into respective example computer commands consistent with present principles; and

FIG. 15 shows an example graphical user interface (GUI) that may be presented on a display to configure one or more options of a device or simulation to operate consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

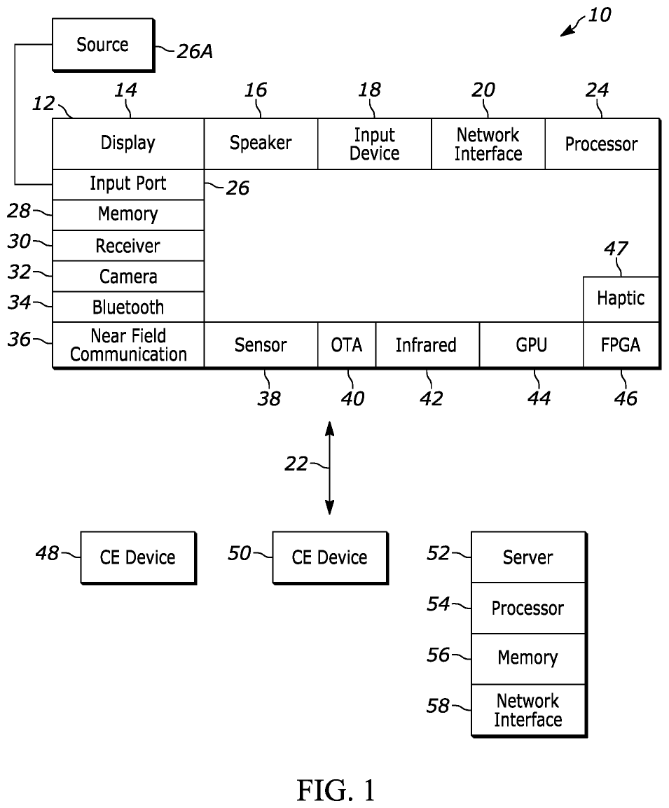

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. Other example input devices include gamepads or mice or keyboards.

The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the aforementioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

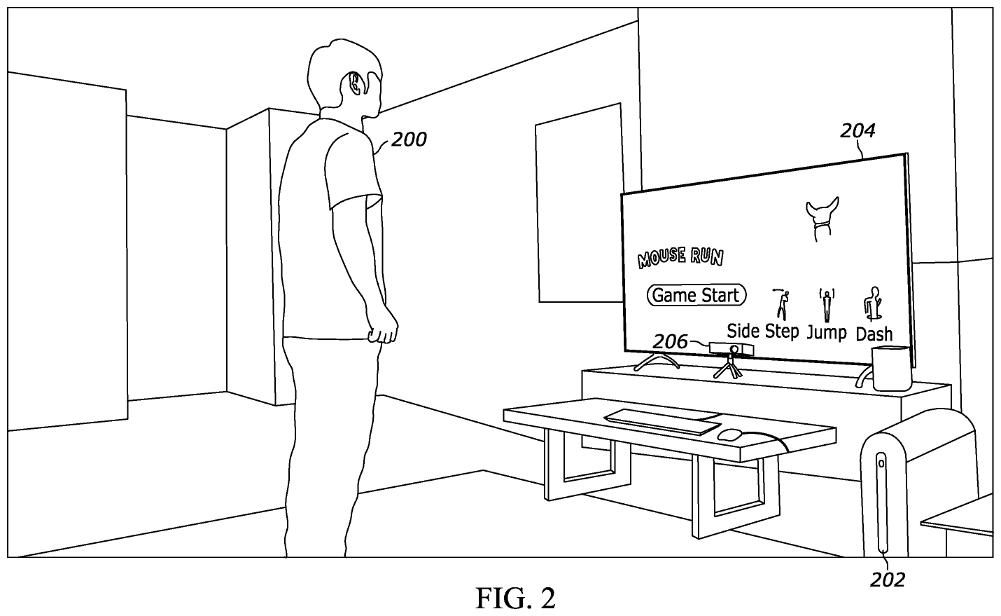

Referring now to FIG. 2, an end-user 200 is shown in front of an example hardware setup that may be used consistent with present principles. The hardware setup may include a computer 202, display 204, and camera 206. In various examples, the computer 202 may be a computer game console or personal computer and may communicate with a remotely-located cloud server to execute and present video game graphics on the display 204. The display 204 may be a computer monitor or television, for example, and may be connected to the computer 202 through a high definition multimedia interface (HDMI) cable, universal serial bus (USB) cable, Wi-Fi connection, or other type of connection. The computer 202 may be similarly connected to the camera 206, which may be a depth-sensing smart camera that may include plural image sensors for sensing depth via triangulation and other techniques. For example, the camera 206 may be a Kinect depth-sensing camera or a Sony depth-sensing camera. The camera 206 may provide input such as still images and video of the user 200 according to the camera's field of view to the computer 202 for processing, including depth-sensing, object recognition, and motion recognition. Note here that the images may include infrared (IR) images and that the depth-sensing technology that is used may be active IR stereo. However, further note that red green blue (RGB) images/techniques may also be used in addition to or in lieu of IR images/techniques.

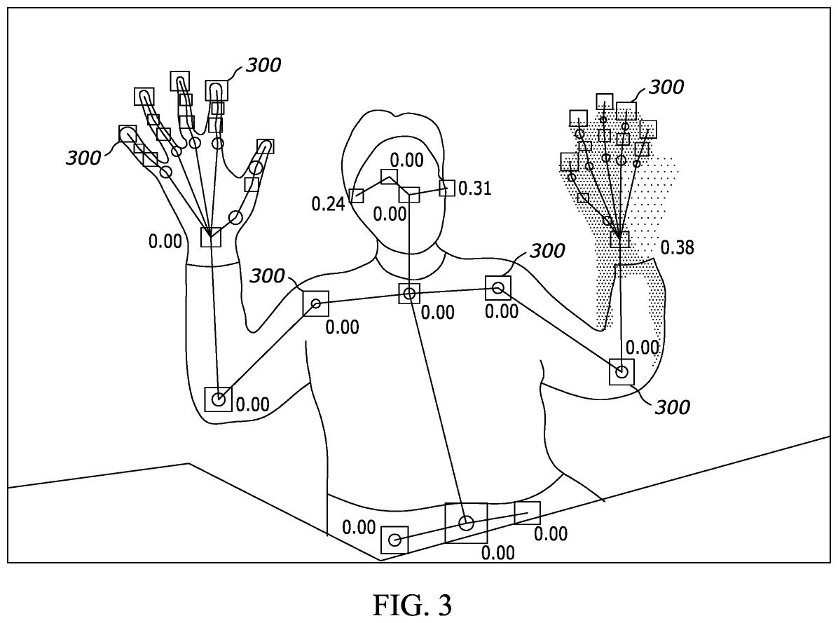

Then, as shown in FIG. 3, the computer 202 by itself or in conjunction with the server may process the input from the camera 206 using feature point detection, object recognition, and/or motion recognition to send body part detection information from the camera 206/computer 202 to the game execution environment to control action of a video game character. For example, feature points 300 of the user as shown in FIG. 3 may be connected to establish a skeletal structure for which motion can be tracked using action/motion recognition to then identify a particular motion or other factor related to the user's upper body. Also note that while in real life the user might move lower extremities to facilitate upper body pose/movement such as upper body leaning, it is upper body feature points and movement that trigger the computer to translate body-based commands into lower body character movement in this example.

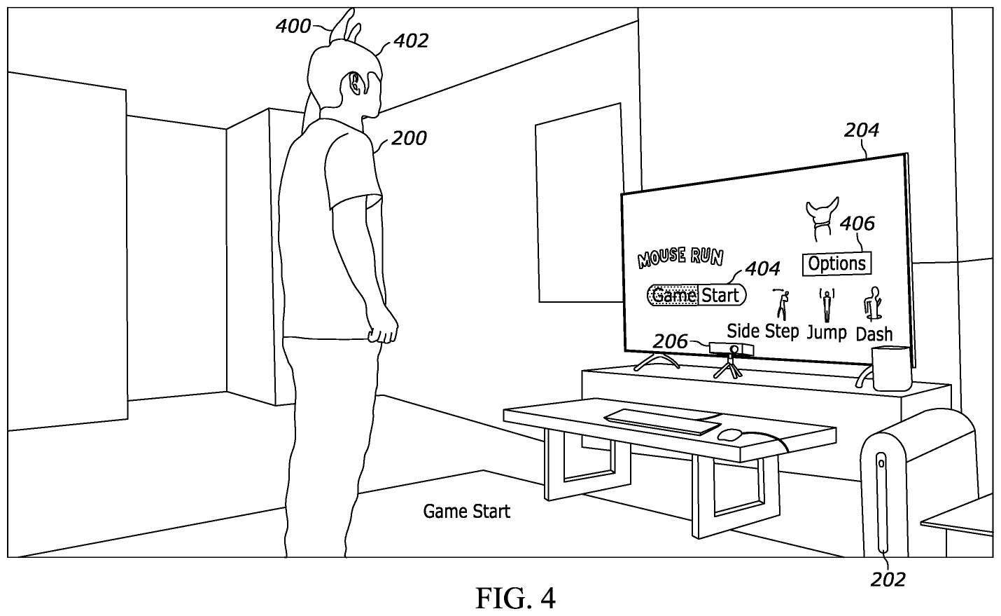

FIG. 4 again shows the same setup as FIG. 2, with the user 200 now raising his left hand 400 above his head 402. As also shown in FIG. 4, a selector/button 404 is presented on a left-hand side of the display 204. Thus, in some examples, based on the selector 404 being the only selector presented on the display 204, the user 200 raising either hand for a threshold amount of time (such as three seconds to avoid false positives) as identified by the computer 202 may be recognized as a command to select the selector 404. Or in another example, based on the selector 404 being on the left-hand half of the display 204 from the user's perspective, the computer 202 may translate a left hand raised for the threshold amount of time as a command to select the selector 404 as presented on the left-hand side of the display 204. Similarly, if a different selector 406 were presented on the right-hand half of the display 204 from the user's perspective, the computer 202 may translate a right hand raised for the threshold amount of time as a command to select the selector 406 as presented on the right-hand side of the display. Further note that in some examples, to help avoid false positives the hand may not just be identified as being raised, but specifically being raised above or over the head 402 of the user 200.

Additionally, note that in the example shown, the selector 406 may be a selector to present a game options screen. Also per the example shown, the selector 404 may be a selector to start execution of a video game and begin presenting the video game, where the video game may be one in which a video game character is subsequently controlled by the user 200 according to one or more factors related to the user's upper body. Also note that, in some examples, a button gauge may be presented as part of the selector 404. The gauge may progressively fill up from left to right over time at a constant rate that matches hand raise time going from zero to the threshold amount of time to visually indicate to the user 200 how long he must continue to continually raise his hand to ultimately select the selector 404.

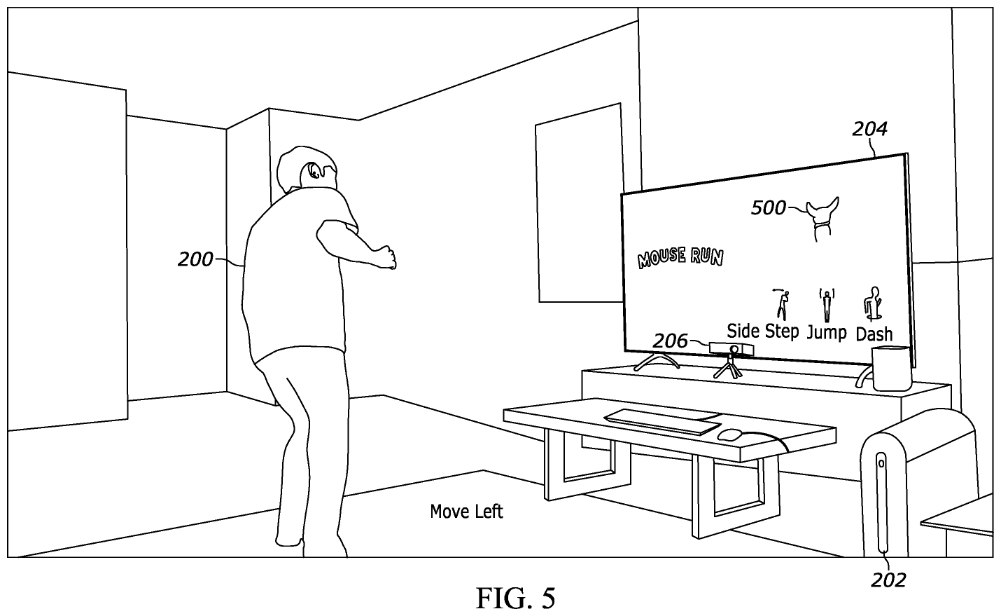

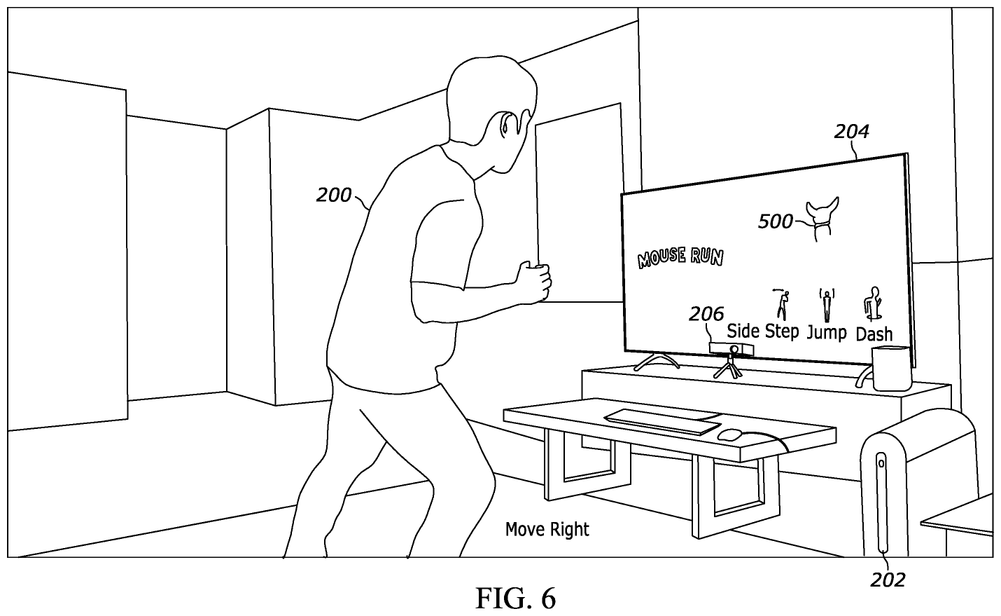

Then during execution of the video game (or other computer simulation), the computer 202 may continue to track the user's upper body pose and motion via input from the camera 206, including tracking spine angle and arm/hand motions. So, for example, the user 200 may lean to the user's left as shown in FIG. 5 and the computer 202 may recognize as much to control lower body motion of a video game character 500 that is presented as part of the game to move the character 500 in a direction within the game scene that is indicated by the upper body lean. So if the character 500 were already walking or running within the game scene, the left-hand lean may command the character 500 to walk/run to the left or farther to the left within the game scene. Likewise, the user 200 might lean to the user's right as shown in FIG. 6 and the computer 202 may thus recognize as much to control lower body motion of the character 500 for the character 500 to walk/run within the game scene to the right or farther to the right. What's more, in some examples the degree of left/right tilt of the lean may translate proportionally into the degree of the character's turn so that the greater the user leans to the left or right, the greater the angle of the character's turn in that direction. The degree of L/R tilt itself may be established by, for example, the angle of an X-Y spinal axis of the user relative to vertical in an X-Y plane extending left to right through the user 200.

As another example of left and right leaning, which may also be tracked based on spine angle as set forth above, suppose the character 500 were standing still instead of walking or running. Responsive to the computer 202 identifying the user 200 as leaning to the user's left, the computer 202 may control the character 500 to move the character's legs for the character 500 to look and/or pivot to its left within the game scene. And responsive to the computer 202 identifying the user 200 leaning to the user's right, the computer 202 may control the character 500 to move the character's legs for the character 500 to look and/or pivot to its right within the game scene.

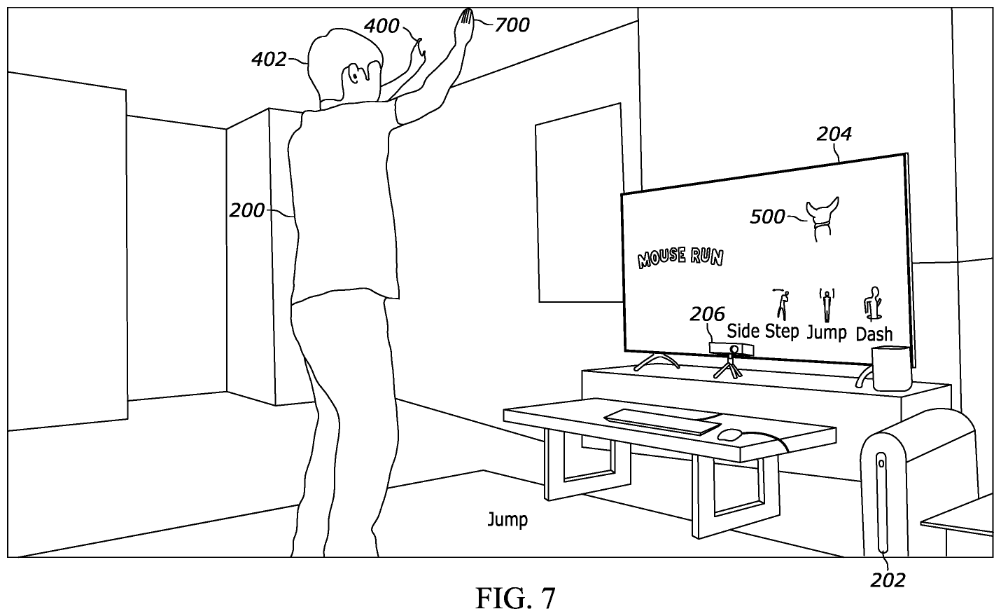

Now in reference to FIG. 7, another example related to the user's upper body being tracked and used to control lower body motion of the character 500 is shown, this time to control the character 500 to jump. Accordingly, here the user's upper body pose is recognized by the computer 202 as both of the user's hands 400, 700 being above the user's head 402. Based on identification of the two hands 400, 700 above the user's head 402, the computer 202 may control execution of the video game to indicate the character 500 as jumping off of the virtual ground into the virtual air and back down again as shown.

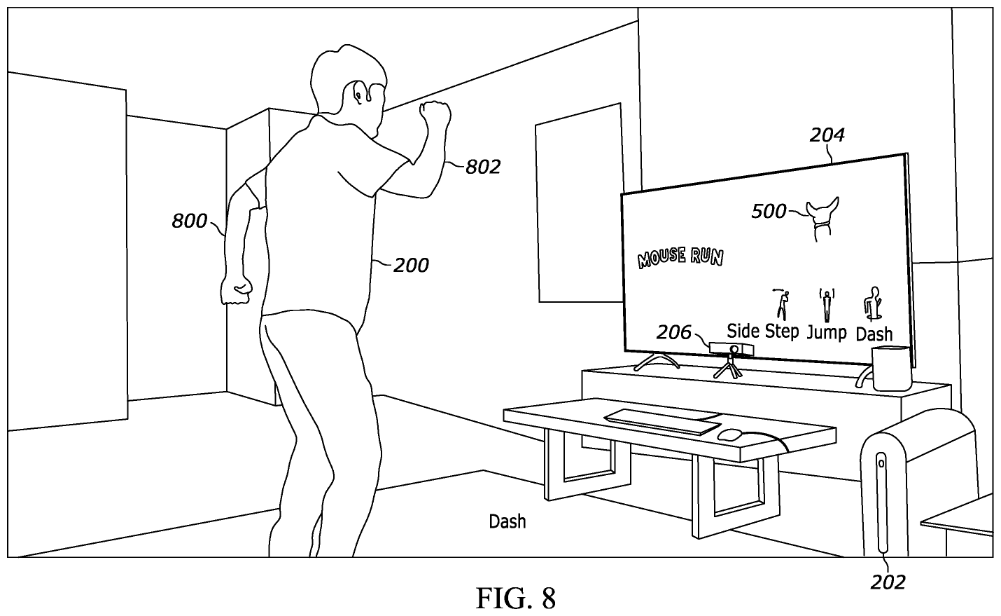

FIG. 8 shows yet another example of the user's upper body being tracked and used to control lower body motion of the character 500, this time for the character 500 to dash/run. Accordingly, in this example the user's upper body motion is recognized by the computer 202 as repeated arm pumping/swinging of both of the user's arms 800, 802 back and forth from front to back. Based on identification of the arm pumping/swinging, the computer 202 may control execution of the video game to indicate the character 500 as running across the virtual ground of the game scene as shown.

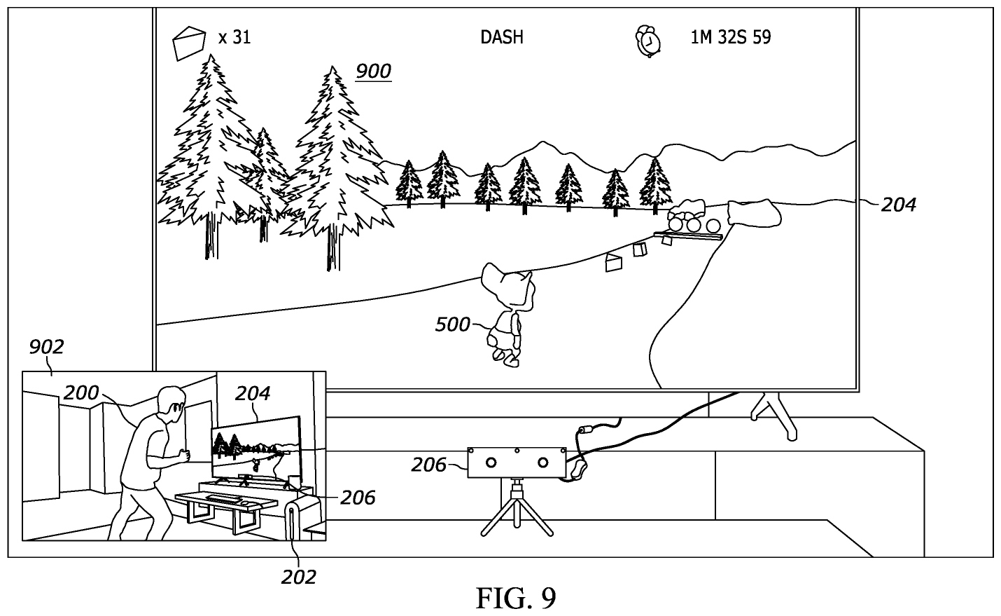

Turning to FIG. 9, it shows an example play screen of the video game 900 as presented on the display 204 during game execution. FIG. 9 therefore shows the character 500 running to the right, which may be a command provided by the user 200 as shown in the split screen 902 based on the user 200 leaning to the right and concurrently pumping his arms.

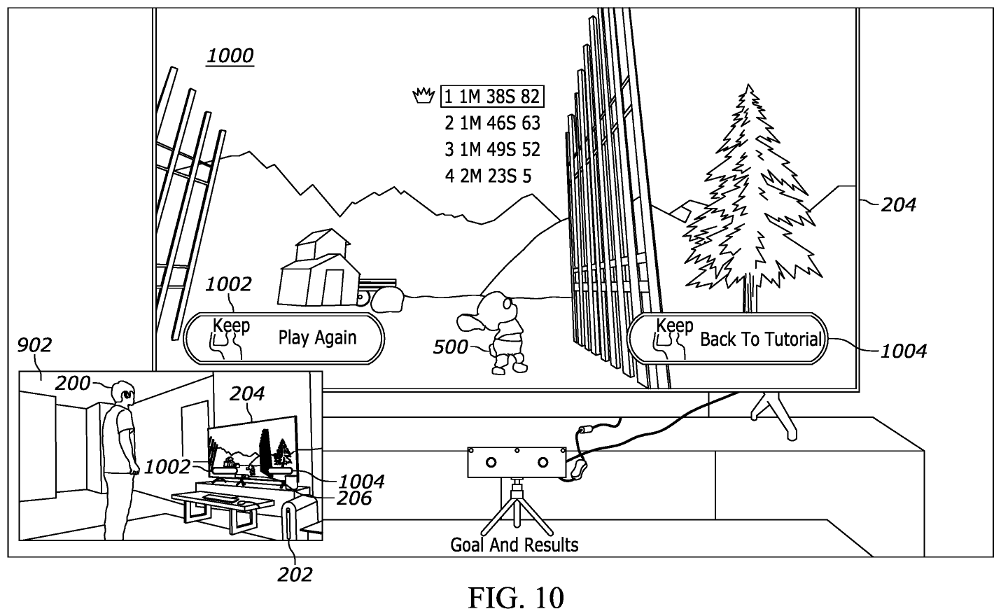

FIG. 10 then shows an example goal and results screen 1000 that may be presented at the end of a level or other aspect of the video game 900. As shown in the split screen 902, the user 200 is standing upright with arms down by his side. Should the user then choose to select the selector 1002 on the left-hand side of the display 204 to command the computer 202 to start the video game again, the user 200 may raise his left hand as described above. To instead select the selector 1004 on the right-hand side of the display to command the computer 202 to return to a game tutorial, the user 200 may raise his right hand as described above. Again note that while in some examples a hand raise (within fingers pointing up) even below the user's head may suffice, to avoid false positives in other non-limiting examples the left or right hand raise may be required to be above the user's head to trigger selection of the corresponding selector.

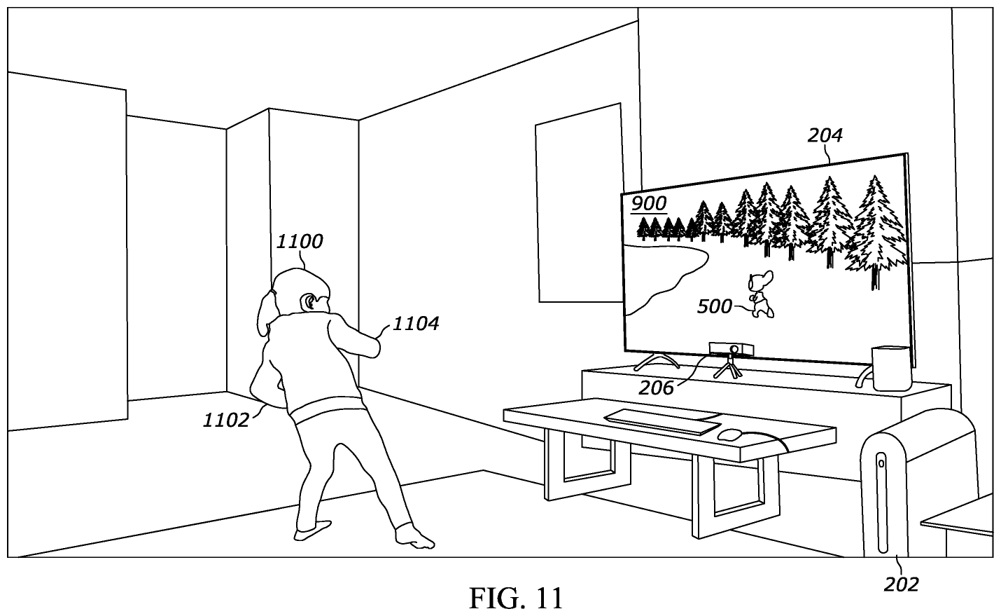

FIG. 11 shows another example consistent with present principles. Here a child 1100 is playing the game 900 to control the character 500 within the game scene, again through computer-based motion tracking using the depth-sensing camera 206. Thus, the child 1100 can lean to her left as shown while pumping/swinging her left and right arms 1102, 1104 to command the character 500 to run to the left.

Additionally, note that in some examples the speed at which the user pumps her arms may be used as input of a particular speed at which the character 500 is to run. So, for example, incrementally faster arm motions may translate into incrementally faster speeds at which the character 500 runs within the scene of the video game 900.

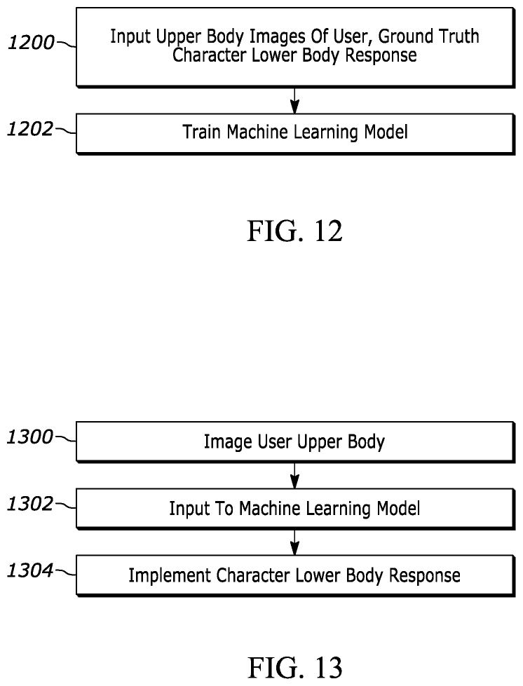

Now in reference to FIG. 12, it shows example logic that may be executed by a computer to train an artificial intelligence/machine learning model to make inferences consistent with present principles. The model may include a recurrent neural network, for example.

Beginning at block 1200, during training upper body images of one or more users may be provided as training input to the machine learning (ML) model along with ground truth/labeled lower body character responses that are to be inferred from the respective upper body image(s). Then at block 1202 the model may be trained consistent with present principles, including via back propagation, to adjust the weights of one or more nodes of the neural network responsive to an incorrect output that does not match the label for the corresponding input image(s).

FIG. 13 then shows example overall logic that may be executed during deployment of the trained model. At block 1300 the computer may image a user's upper body, such as via a depth-sensing camera as described above. The logic may then move to block 1302 where the computer may provide the images from the camera to the ML model and receive an inference output in response. Thereafter the logic may proceed to block 1304 where the computer may implement a simulation character's lower body response based on the lower body response inference output by the ML model.

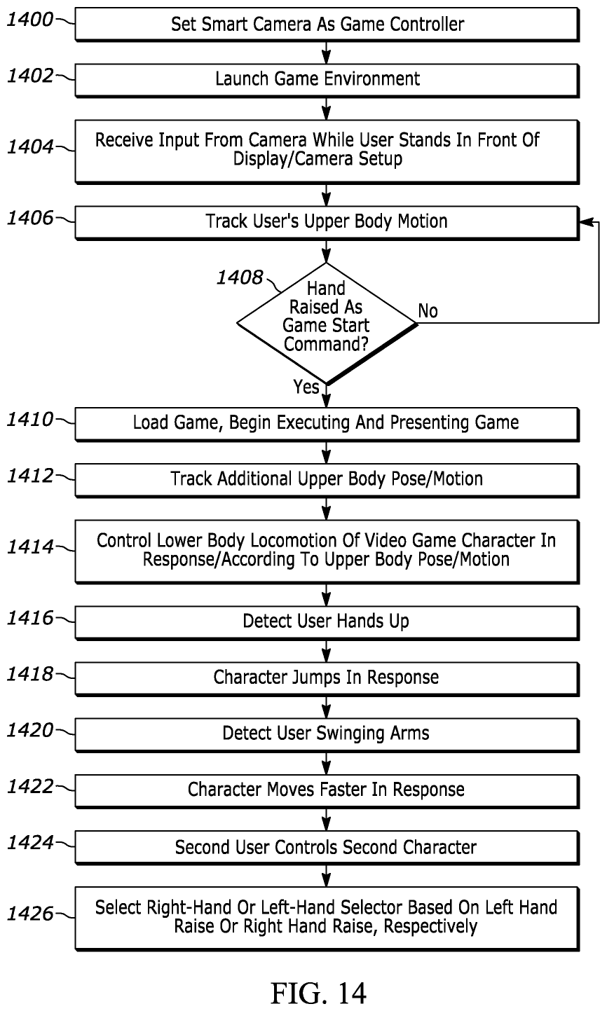

Turning now to FIG. 14, additional example logic is shown that may be executed consistent with the overall logic of FIG. 13 during deployment of the model. Beginning at block 1400, the computer may set its smart camera as a game controller. The computer may do so responsive to user command, responsive to the computer or camera itself being powered on, etc. The user command may be a verbal command or a command provided at a setup screen for the console/game, for example.

The logic may then move to block 1402 where the computer may launch a game or other simulation environment. For example, at block 1402 the computer may execute one or more game files to present a welcome screen, home screen, settings screen, or other screen from which various options may be selected to then start an ensuing video game instance.

From block 1402 the logic may then proceed to block 1404. At block 1404 the computer may receive input from the camera while the user stands in front of the display/camera setup. The logic may then proceed to block 1406 where the device may track the user's upper body motion based on the camera input to determine, at diamond 1408, whether a user's hand has been raised to indicate a game start command. Responsive to a negative determination at diamond 1408, the logic may revert back to block 1406 and proceed again therefrom. However, responsive to an affirmative determination at diamond 1408, the logic may instead proceed to block 1410.

At block 1410 the computer made load a game/instance and begin executing and presenting the game. The logic may then proceed to block 1412 where the computer may continue receiving input from the camera to track additional upper body factors related to upper body pose and/or motion to, at block 1414, control lower body locomotion of a video game character in response to and according to the upper body pose/motion. So, for example, a leftward lean (pose) and/or arm swinging (motion) may result in the character walking or running to the left.

Additional upper body pose/motion may continue to be tracked after that. For example, from block 1414 the logic may proceed to block 1416 where the computer may receive additional input from the camera to detect the user's hands as being raised above the user's head. In response, at block 1418 the computer may control the video game character to jump. As another example, the logic may proceed to block 1420 where camera input may be received and analyzed to detect the user's arms as swinging or, alternatively, swinging at a different speed than might have been detected at block 1412. In response, at block 1422 the computer may move the character faster or slower in the game world according to the change in speed.

Thus, in one example the character may move forward at a default speed based merely on an upper body lean, such as a lean forward to move forward, a lean left to move left, a lean right to move right, or a lean back to move backward. Per this example, arm swinging on top of that may then command the character to move faster than the default speed according to swing speed and direction of lean at block 1422.

However, in another example, character movement may be instigated in the first place by arm swinging, with frontward, backward, left or right leaning indicating direction of the movement. So at block 1422 according to this example, a detected change in arm swinging to a faster speed may result in the character moving faster, whereas a detected change in arm swinging to a slower speed may result in the character moving slower.

Still in reference to FIG. 14, the logic may then proceed to block 1424. At this step the computer may track upper body pose and motion of a second user that might be playing the same game/instance with the other user and similarly control lower body movement of a second character tied to the second user in response. The computer may also execute other actions based on upper body motions of the second user consistent with present principles.

For example, at block 1426, should either user raise a right hand while a first selector is presented on a right half of the display, the computer may translate that as a command to select the first selector and execute the corresponding selection operation accordingly. Should either user raise a left hand while a second selector is presented on a left half of the display, the computer may translate that as a command to select the second selector and execute the corresponding selection operation accordingly.

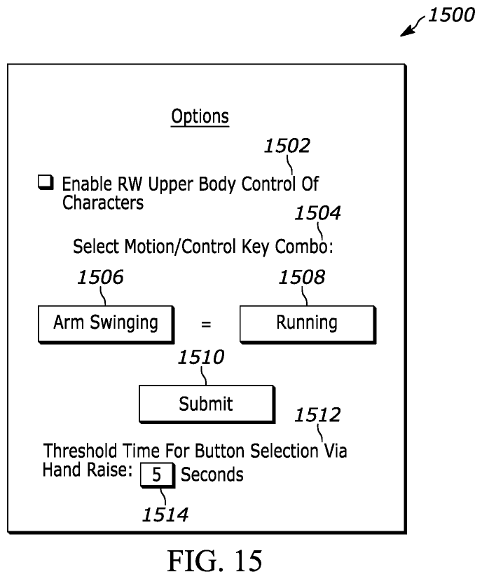

Now describing FIG. 15, it shows an example graphical user interface (GUI) 1500 that may be used to configure one or more settings of a computer or computer simulation to operate consistent with present principles. The GUI 1500 may be presented by navigating a device, operating system, or game menu of the computer, for example. Also per this example, each option to be discussed below may be selected by directing touch, cursor, or other input to the check box adjacent to the respective option.

As shown in FIG. 15, the GUI 1500 may include an option 1502 that may be selectable to configure the computer to undertake present principles (e.g., selectable a single time to set the computer to track real-world upper body movement of a user and use that as input to control lower body locomotion of a simulation character in multiple future instances). Thus, selection of the option 1502 may set or enable the device to undertake the functions described above in reference to FIGS. 2-14 for example.

The GUI 1500 may also include a section 1504 at which an end-user may select a particular upper body motion/lower body control key combination for the computer to use. Thus, selector 1506 may be selected to cause a drop-down menu to be presented beneath it from which an available upper body motion may be selected (e.g., one for which the ML model has been trained). The selector 1508 may then be selected to cause another drop-down menu to be presented beneath it from which an available lower body character motion may be selected. The user may then select the submit selector 1510 to establish the selected combination in settings for the computer to then apply during a computer simulation. In the present example, the end-user has selected real-world arm swinging to translate into virtual character running.

As also shown in FIG. 15, in some examples the GUI 1500 may include another setting 1512 for the user to establish a threshold amount of time that a hand should be continually raised for the computer to translate the hand raise into a button selection command. Thus, the user may enter numerical input into input box 1514 using a hard or soft keyboard to establish the threshold amount of time. In the present example, the user has set the threshold amount of time at five seconds.

Moving on from FIG. 15, note consistent with present principles that a computer simulation that may be controlled based on one or more factors related to a user's upper body may include not only traditional video games presented on a TV screen but also, for example, augmented reality (AR), virtual reality (VR), and/or mixed reality (MR) games presented stereoscopically using a headset. The computer simulation might also be a non-game type of AR, VR, and/or MR simulation, such as a first-person point of view VR simulation or even another type of computer simulation more generally. For example, the simulation might be movement of a 3D model or avatar presented on a Sony spatial reality display (or other type of holographic display) that is not necessarily tied to a video game per se.

Also note consistent with present principles that a user's upper body may include parts of the body other than lower extremities forming the lower body (the lower body including pelvis and hips, legs including knees and ankles, and feet). Accordingly, the upper body may include parts above the pelvis and hips, including stomach and torso, spine, arms, hands, shoulders, neck, and head.

While the particular embodiments are herein shown and described in detail, it is to be understood that the subject matter which is encompassed by the present invention is limited only by the claims.

What is claimed is:

1. An apparatus comprising:
at least one processor configured to:
receive input from a camera;
based on the input, identify at least one factor related to a user's upper body; and
based on identification of the at least one factor related to the user's upper body, control lower body motion of a video game character according to the at least one factor.

2. The apparatus of claim 1, wherein the at least one factor comprises an upper body lean to one of: the left, the right.

3. The apparatus of claim 2, wherein the processor is configured to:
based on identification of the upper body lean, control the lower body motion of the video game character to move in a direction indicated by the upper body lean.

4. The apparatus of claim 1, wherein the at least one factor comprises upper body arm motion.

5. The apparatus of claim 4, wherein the upper body arm motion comprises arm pumping, and wherein the processor is configured to:
based on identification of the arm pumping, control the lower body motion of the video game character to run.

6. The apparatus of claim 1, wherein the at least one factor comprises two hands above the user's head, and wherein the processor is configured to:
based on identification of the two hands above the user's head, control the lower body motion of the video game character to jump.

7. The apparatus of claim 1, wherein the input is first input, and wherein the processor is further configured to:
receive second input from the camera;
based on the second input from the camera, identify a raised hand; and
based on identification of the raised hand, begin presenting a video game in which the video game character is controlled according to the at least one factor.

8. The apparatus of claim 1, wherein the input is first input, and wherein the processor is further configured to:
receive second input from the camera; and
based on the second input indicating a raised left hand, select a first selector presented on a left-hand side of a display.

9. The apparatus of claim 8, wherein the processor is configured to:
based on the second input indicating a raised right hand, select a second selector presented on a right-hand side of a display, the second selector being different from the first selector.

10. The apparatus of claim 1, comprising the camera.

11. The apparatus of claim 10, wherein the camera is a depth-sensing camera.

12. A method, comprising:
receiving input from a camera;
based on the input, identifying at least one factor related to a user's upper body; and
based on identifying the at least one factor related to the user's upper body, controlling execution of a computer simulation to indicate lower body motion of a simulation character according to the at least one factor.

13. The method of claim 12, wherein the computer simulation comprises a game.

14. The method of claim 12, wherein the at least one factor comprises an upper body lean to one of: the left, the right; and
wherein the method comprises:
based on identifying the upper body lean, controlling execution of the computer simulation to indicate the lower body motion of the simulation character to move in a direction indicated by the upper body lean.

15. The method of claim 12, wherein the at least one factor comprises arm swinging; and
wherein the method comprises:
based on identifying the arm swinging, controlling execution of the computer simulation to indicate the simulation character as running.

16. The method of claim 12, wherein the at least one factor comprises two hands above the user's head, and wherein the method comprises:
based on identifying the two hands above the user's head, controlling execution of the computer simulation to indicate the simulation character as jumping.

17. The method of claim 12, wherein the input is first input, and wherein the method further comprises:
receiving second input from the camera; and
based on the second input indicating a raised hand, selecting a selector presented on a display.

18. A device comprising:
at least one computer storage that is not a transitory signal and that comprises instructions executable by at least one processor to:
receive input from a camera;
based on the input, identify at least one factor related to a user's upper body; and
based on identification of the at least one factor related to the user's upper body, control execution of a computer simulation to indicate lower body motion in the computer simulation according to the at least one factor.

19. The device of claim 18, wherein the lower body motion comprises running.

20. The device of claim 18, wherein the lower body motion comprises jumping.
